(19) United States
(12) Patent Application Publication
(10) Pub. No.: US 2007/0065700 A1
(43) Pub. Date: Mar. 22, 2007

(54) High temperature polymer electrolyte membranes

(75) Inventors: Gary Koolpe, Tracy, CA (US); Susanna C. Ventura, Los Altos, CA (US)

Correspondence Address: LUMEN INTELLECTUAL PROPERTY SERVICES, INC., 2345 YALE STREET, 2ND FLOOR, PALO ALTO, CA, 94306, US

(73) Assignee: SRI International

(21) Appl. No.: 11/396,426

(22) Filed: Mar. 30, 2006

Related U.S. Application Data
(60) Provisional application No. 60/720,348, filed on Sep. 22, 2005.

(51) Int. Cl. H01M 8/10; C08J 5/20; H01M 10/40; C25C 7/04

(52) U.S. Cl. 429/33; 521/25; 204/296; 429/314; 429/317; 429/316

(57) ABSTRACT

Sulfonated polymer compositions including a polymer or copolymer derived from the monomer 2,2′-di-(4,4′dihydroxyphenyl) pentafluoropropanesulfonic acid are provided. Such compositions can provide improved polymer electrolyte membranes, especially in preferred embodiments including polybenzimidazole and polyacrylonitrile in the composition. These membranes can provide high ion conductivity in combination with improved thermal and mechanical stability, and are especially suitable for high temperature operation. Applications of such membranes include fuel cell electrolytes, electrolyzer electrolytes and battery electrolytes.

### CROSS REFERENCE TO RELATED APPLICATIONS

This application claims the benefit of U.S. provisional application 60/720,348, filed on Sep. 22, 2005, entitled “High Temperature Polymer Electrolyte Membranes”, and hereby incorporated by reference in its entirety. This application also claims the benefit of U.S. application Ser. No. 09/872,770, filed on Jun. 1, 2001, and entitled “Polymer Composition”.

### FIELD OF THE INVENTION

This invention relates to polymer electrolyte membranes.

### BACKGROUND

Polymer electrolyte membranes are useful for various applications, such as fuel cells, electrolyzers, and batteries. In particular, high-temperature proton-exchange membrane (PEM) fuel cells offer several advantages. The proton-exchange membrane combines in one material the function of electrolyte and separator. Additionally, proton-exchange membranes are readily fabricated in thin flexible films and therefore allow the fabrication of thin devices with variable shape. It is desirable to operate fuel cells at temperatures higher than 100° C. at moderate relative humidity to minimize anode catalyst poisoning by carbon monoxide and to enhance reaction kinetics at the electrodes and thereby increase fuel cell efficiency. In addition, high-temperature proton exchange membranes that operate at moderate to high temperature (120° C.-200° C.) can provide higher water electrolysis efficiency, since the electrical efficiency of steam electrolysis increases with temperature, owing to the decrease in both thermodynamic (open circuit) potential and electrode polarization (so that the kinetics at the electrodes are considerably faster). However, commercially available perfluorinated hydrocarbon sulfonated ionomers are known to be chemically unstable at temperatures higher than 80° C.-100° C. and therefore cannot be used for this promising application.

Sulfonated polymers have been extensively investigated for use in polymer electrolyte membranes. Representative examples of the state of the art in this field include US 2006/0030683, U.S. Pat. No. 6,632,847, U.S. Pat. No. 6,869,980, U.S. Pat. No. 6,955,712, US 2005/0037265, U.S. Pat. No. 6,933,068, and US 2002/0091225. Blends or co-polymers including sulfonated polymers have also been investigated for use in polymer membranes, including electrolyte membranes, as in U.S. Pat. No. 6,264,857, U.S. Pat. No. 5,219,679, and EP 0,337,626. However, despite these extensive investigations, it remains challenging to provide polymer electrolyte membranes suitable for demanding applications requiring high proton conductivity, thermal and electrochemical stability, and high mechanical strength for various temperature and humidity conditions. More specifically, polymer electrolyte membranes should have excellent chemical and electrochemical stability up to 150° C.-200° C., high proton conductivity, and excellent mechanical properties. A significant challenge is to develop polymer membranes for which all the requirements-high proton conductivity, thermal and electrochemical stability, and mechanical strength-are met under variable temperature and humidity conditions.

While several reports claiming high-temperature polymer membranes have been made, data relating to fuel cells or electrolyzers at high temperatures is typically not provided. Some examples of materials proposed for high-temperature membranes include sulfonated polyimide membranes, sulfonated polyphenyleneoxide, sulfonated polyquinoxalines, sulfonated polyphenylenes, sulfonated polyetheretherketone (PEEK), sulfonated polyethersulfones, blends of fluorinated sulfonated polyetherethersulfones and polybenzimidazole, blends of sulfonated polyetherketone and polybenzimidazole, sulfonated aromatic polymers supported on porous polybenzoxazole, and so on. In general, much current work is focused on developing high-temperature polymer electrolyte membranes for PEM fuel cells for which it is especially desirable to operate the fuel cell at moderate humidity to simplify water management and fuel cell stack design. On the other hand, polymer membranes for water electrolyzers need to operate in the presence of water in the liquid phase at high temperature (>120° C.), need to have very large area, require excellent mechanical properties, and need to be able to operate over tens of thousands of hours without significant degradation.

Accordingly, it would be an advance in the art to provide polymer electrolyte membranes suitable for such demanding applications, especially for high temperature operation.

### SUMMARY

Sulfonated polymer compositions including a polymer or copolymer derived from the monomer 2,2′-di-(4,4′dihydroxyphenyl)pentafluoropropanesulfonic acid are provided. These compositions provide high ionic conductivity due to the strongly acidic functional group. Such compositions can provide improved polymer electrolyte membranes, especially in preferred embodiments including polybenzimidazole and polyacrylonitrile in the composition. Such improved polymer electrolyte membranes can provide high ion conductivity in combination with improved thermal and mechanical stability, and are especially suitable for high temperature operation. Applications of such membranes include fuel cell electrolytes, electrolyzer electrolytes and battery electrolytes.

### BRIEF DESCRIPTION OF THE DRAWINGS

FIG. 1 shows a monomer suitable for fabricating an embodiment of the invention.

FIG. 2 shows a polymer according to an embodiment of the invention.

FIG. 3 shows another polymer according to an embodiment of the invention.

FIG. 4 shows a chemical structure suitable for fabricating embodiments of the invention.

FIG. 5 shows a chemical structure present in a repeating monomer unit of a polymer or co-polymer according to the invention.

FIGS. 6a-d show a synthesis process suitable for making an embodiment of the invention.

FIG. 7 shows a synthesis process suitable for making another embodiment of the invention.

FIG. 8 shows a synthesis process suitable for making yet another embodiment of the invention.

### DETAILED DESCRIPTION

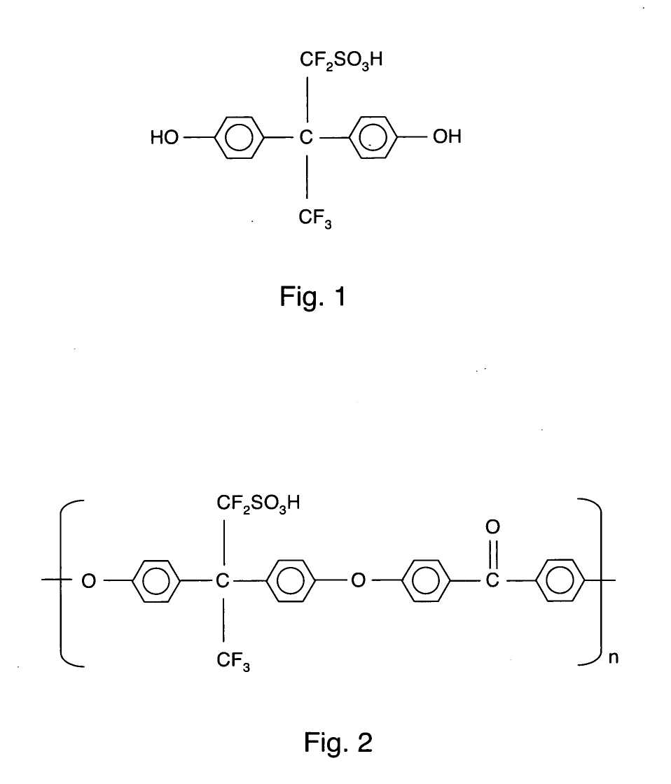

FIG. 1 shows a monomer suitable for fabricating an embodiment of the invention. More specifically, the monomer of FIG. 1 is 2,2′-di-(4,4′dihydroxyphenyl) pentafluoropropanesulfonic acid. This monomer is functionalized by the strongly acidic difluoromethylene sulfonic acid group (i.e., —CF₂SO₃H). The strongly acidic functional group is preferred for increasing proton conductivity.

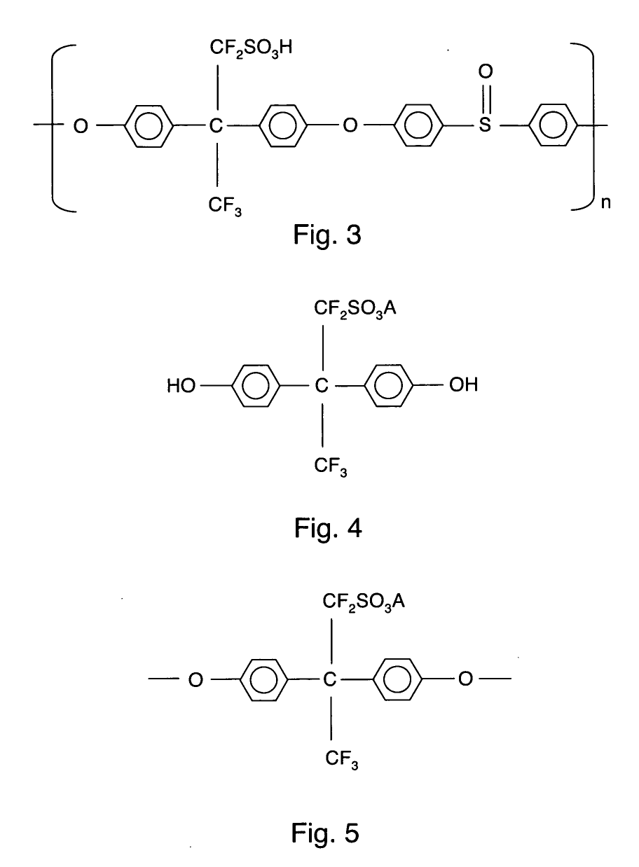

FIG. 2 shows a polymer according to an embodiment of the invention. More specifically, the polymer of FIG. 2 is a polyetheretherketone which can be synthesized by condensation of 2,2′-di-(4,4′dihydroxyphenyl)pentafluoropropanesulfonic acid with 4,4′-difluorobenzophenone. FIG. 3 shows another polymer according to an embodiment of the invention. More specifically, the polymer of FIG. 3 is a polyetherethersulfone which can be prepared by condensation of 2,2′-di-(4,4′dihydroxyphenyl)pentafluoropropanesulfonic acid with 4,4′-difluorobenzosulfone. In addition to polyetheretherketones and polyetherethersulfones, other polymers that can be prepared from this monomer include polyesters, polyetherimides, and other polyethers.

The examples of FIGS. 2-3 show highly acidic polymers functionalized by the difluoromethylene sulfonic acid group (i.e., —CF₂SO₃H), where substitution of the acidic group is not on the aromatic rings of the polymer backbone. This desirable characteristic is in sharp contrast to most conventional sulfonated aromatic polymers, where the sulfonic acid groups are typically substituted on the aromatic rings of the polymer backbone. Such substitution typically provides polymer electrolytes with much less acidity, undesirably tending to reduce proton conductivity. The aromatic hydrocarbon backbone of polymers such as in FIGS. 2 and 3 advantageously provides mechanical and thermal stability.

In preparing polymer compositions according to the invention, alkali salts of the acid of FIG. 1 can be employed. Thus the monomers of interest are generally as shown in FIG. 4, where A is H or an alkali metal (e.g., Li, Na, K, Rb, Cs). Similarly, in general terms polymers (or co-polymers) according to the invention include the chemical structure of FIG. 5 within a repeating monomer unit of the polymer or co-polymer.

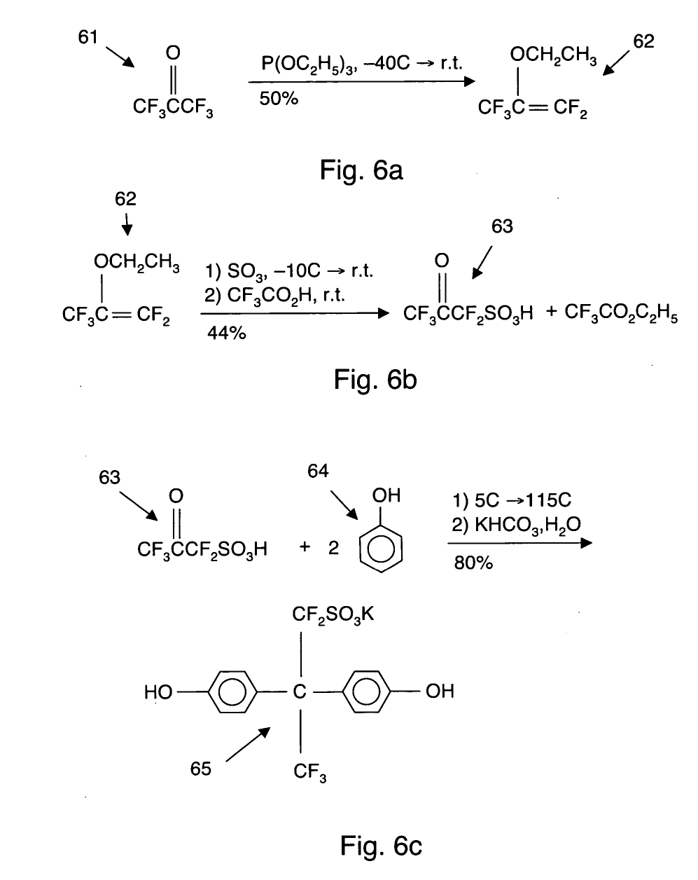

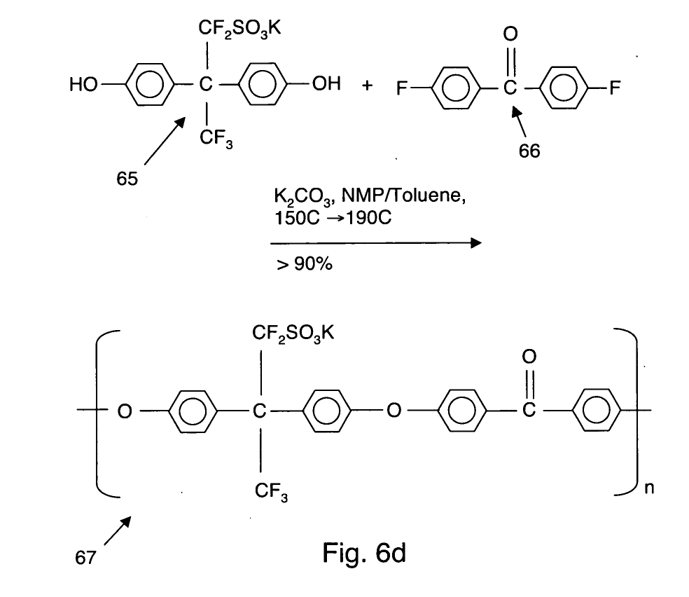

FIGS. 6a-d show an exemplary synthesis procedure for fabricating an embodiment of the invention. In summary, condensation of 2-ketopentafluoropropanesulfonic acid 63 with phenol neat 64 at 115° C. affords the potassium salt 65 of 2,2-(4,4′-hydroxyphenyl)pentafluoropropanesulfonic acid in greater than 80% yield after deprotonation with potassium bicarbonate (FIG. 6c). Anionic polymerization of monomer 65 with 4,4′-difluorobenzophenone 66 in 1-methyl-2-pyrollidinone/toluene at 195° C. affords a highly conductive, thermally stable polymer electrolyte 67 in greater than 90% yield. Polymer 67 can be converted to the acid form of FIG. 2 with known techniques.

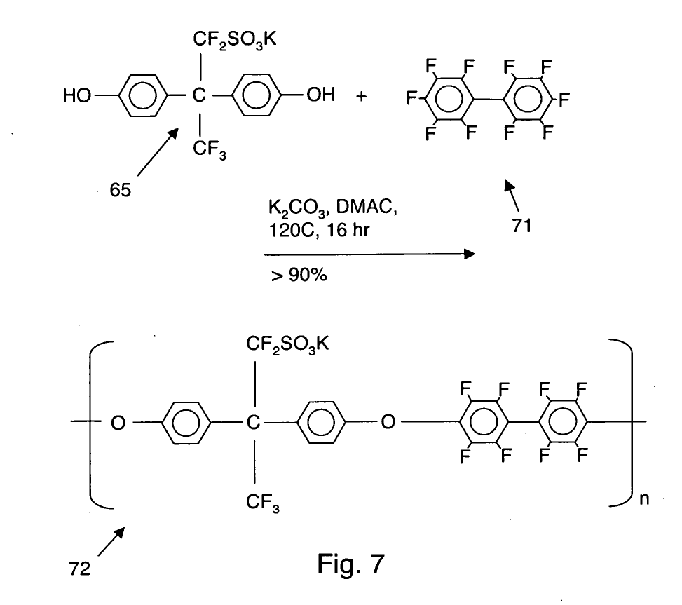

FIG. 7 shows a synthesis process for another embodiment of the invention (Example 1). In a 100 ml three neck round bottom flask equipped with a mechanical stirrer and a reflux condenser, 2.065 g (4.732 mmol) of potassium 2,2-bis(p-hydroxyphenyl)pentafluoropropanesulfonate 65, 1.581 g (4.732 mmol) of decafluorobiphenyl 71, and 0.790 g (5.678 mmol) of potassium carbonate were added. The reaction vessel was evacuated, placed under argon and 14.5 g of N,N-dimethylacetamide (DMAC) was added. The mixture was then heated to 120° C. over 30 minutes with stirring under argon and held at 120° C. for 16 hours. After cooling, the DMAC was distilled off under vacuum. The residual solid was heated with ethyl acetate and filtered. The solid was then heated with 1% aqueous acetic acid, filtered and dried to give 3.289 g (95%) of polymer 72.

Example 2: Polymer 72 (1.70 g, 2.32 mmol) was dissolved in 50 ml of methanol and acidified by the addition of 300 mg (3.0 mmol) of sulfuric acid in 5 ml of methanol. The colorless solution was dialyzed over 30 hours in 3500 M.W. cutoff tubing, decanted, and freeze dried to afford 1.48 (2.13 mmol) of the acid form of polymer 72 as a colorless powder.

Example 3: Polymer 67 (0.25 g) was dissolved in dimethylacetamide (2.0 g). The resulting solution was applied onto a 1″×2″ glass substrate. After evaporating the solvent overnight at 50° C., the membrane was peeled off from the substrate and soaked in 1 M sulfuric acid overnight. The polymer membrane was then repeatedly washed with water and dried in a vacuum plate at 40° C. The resulting membrane was tested for its proton conductivity at 120° C. and 50% relative humidity by AC impedance analysis. Under these conditions the membrane conductivity was found to be 5 mS/cm.

The performance of polymer electrolyte membranes according to embodiments of the invention can be improved by combining compositions as described above with other materials to provide co-polymers and/or mixtures. More specifically, membranes including sulfonated polymers of the invention can be blended with polybenzimidazole (PBI) to enhance mechanical stability in water at 150° C. Preferably, polyacrylonitrile (PAN) is also included with PBI in such blends. The advantages provided by a blend including PBI and PAN are indicated by the following example.

Example 4: A polymer membrane was prepared from a blend of the sulfonic acid polymer of FIG. 2 with polybenzimidazole and polyacrylonitrile. First the sulfonic acid polymer and PBI were mixed in the ratio 98:2 in dimethylacetamide, then 1% PAN (% calculated with respect to the total weight of the sulfonic acid polymer and PBI) was added to the polymer blend solution. After solvent evaporation, the resulting polymer membrane was immersed in water at 150° C. under pressure. After 24 hours testing under these conditions, the membrane did not deform much and was still flexible. In the absence of PAN, the membrane expanded greatly and became brittle.

Sulfonated polymers of the invention can be formulated with phosphoric acid, triazole, low molecular weight imidazoles, phosphotungstic acid and other strong inorganic acids to enhance proton conductivity at low relative humidities. Co-polymerization of sulfonated polymers of the invention with other monomers can be used to select the degree of hydrophobic/hydrophilic character of the composition.

Copolymers according to the invention can be fabricated. For example, a copolymer can be prepared by condensation of the monomer of FIG. 4 with 4,4′-(hexafluoroisopropylidene)diphenol and 4,4′-difluorobenzophenone. Alternatively, a copolymer can be prepared by condensation of the monomer of FIG. 4 with 4-4′-(hexafluoroisopropylidene)diphenol and bis(4-fluorophenyl)sulfone. Copolymers with suitable relative amount of sulfonic acid monomers and non-polar monomers can be prepared to achieve microscopic phase separation into hydrophilic and hydrophobic domains to achieve optimum conductivity at low relative humidity. A preferred composition is a copolymer with 30% or more of the polymer repeating units containing the sulfonic acid block.

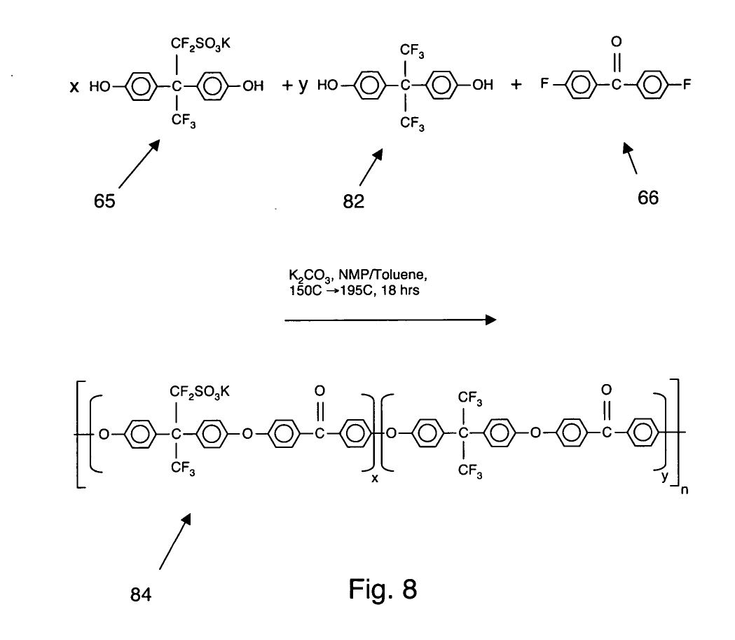

FIG. 8 shows an example (Example 5) of copolymer synthesis according to an embodiment of the invention. In a 100 mL three neck round bottom flask equipped with a mechanical stirrer and a reflux condenser, 3.055 g (7 mmol) of potassium 2,2′-bis(p-hydroxyphenyl) pentafluoropropanesulfonate 65, 1.009 g (3 mmol) of 4,4′-(hexafluoroisopropylidene)diphenol 82, 2.181 g (10 mmol) 4,4′-difluorobenzophenone 66, 1.59 g (11.5 mmol) of potassium carbonate and 40.4 g of 1-methyl-2-pyrrolidinone was added. The reaction vessel was evacuated, placed under argon, and 24 g of toluene was added. The mixture was heated to 145-150° C. for three hours to distill off the water/toluene azeotrope, and was then heated to 195° C. and held at that temperature for 18 hours. After cooling the solvent was distilled under vacuum. The residual solid (i.e., polymer 84) was heated with 1% aqueous acetic acid and the solid was filtered and dried. The solid was suspended sequentially in hot ethyl acetate and hot ethyl acetate/methanol (3:1) and the solid was filtered and dried. In this example, x=0.7 and y=0.3.

Polymer compositions according to the invention have numerous applications, including fuel cells, electrolyzers, batteries, energy storage devices, chemical sensors, electrochromic devices and electrochemical devices. Especially noteworthy applications include fuel cell electrolyte membranes and lithium ion conductors for batteries.

1. A composition comprising a polymer or copolymer having one or more repeating monomer units, wherein one of the repeating monomer units includes the following chemical structure: 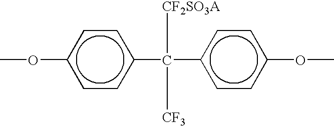
and wherein A is selected from the group consisting of hydrogen and alkali metals.

2. The composition of claim 1, wherein said sulfonated polymer comprises a polymer selected from the group consisting of polyetheretherketones, polyetherethersulfones, polyesters, polyetherimides, and polyethers.

3. The composition of claim 1, further comprising polybenzimidazole.

4. The composition of claim 3, further comprising polyacrylonitrile.

5. The composition of claim 1, further comprising an ionic conductivity enhancer selected from the group consisting of phosphoric acid, triazole, low molecular weight imidazoles, phosphotungstic acid, and strong inorganic acids.

6. The composition of claim 1, wherein 30% or more of polymer repeating units of the composition include a sulfonic acid functional group.

7. A polymer electrolyte membrane comprising the polymer composition of claim 1.

8. Apparatus comprising the polymer electrolyte membrane of claim 7, wherein the apparatus is selected from the group consisting of fuel cells, electrolyzers, batteries, energy storage devices, chemical sensors, electrochromic devices and electrochemical devices.

9. The apparatus of claim 8, wherein said polymer electrolyte membrane operates at a temperature greater than about 120° C.

10. A polymer composition comprising a polymer product of a polymerization or copolymerization reaction including a monomer having the following chemical structure: 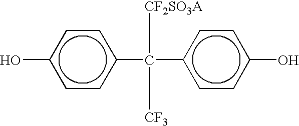
as a reactant, wherein A is selected from the group consisting of hydrogen and alkali metals.

11. The composition of claim 10, wherein said polymer product comprises a polyetheretherketone prepared by condensation of said monomer with 4,4′-difluorobenzophenone.

12. The composition of claim 10, wherein said polymer product comprises a polyetherethersulfone prepared by condensation of said monomer with 4,4′-difluorobenzosulfone.

13. The composition of claim 10, wherein said polymer product comprises a copolymer prepared by condensation of said monomer with 4,4′-(hexafluoroisopropylidene)diphenol and 4,4′-difluorobenzophenone.

14. The composition of claim 10, wherein said polymer product comprises a copolymer prepared by condensation of said monomer with 4-4′-(hexafluoroisopropylidene)diphenol and bis(4-fluorophenyl)sulfone.

15. The composition of claim 10, wherein 30% or more of polymer repeating units of the composition include a sulfonic acid functional group.
